(19) United States
(12) Patent Application Publication
(10) Pub. No.: US 2011/0299737 A1
(43) Pub. Date: Dec. 8, 2011

(54) VISION-BASED HAND MOVEMENT RECOGNITION SYSTEM AND METHOD THEREOF

(75) Inventors: JING-WEI WANG, LOS ANGELES, CA (US); CHUNG-CHENG LOU, TAIPEI (TW)

(73) Assignee: ACER INCORPORATED, TAIPEI COUNTY (TW)

(21) Appl. No.: 12/793,686

(22) Filed: Jun. 4, 2010

(51) Int. Cl. G06K 9/00

(52) U.S. Cl. 382/107

(57) ABSTRACT

A vision-based hand movement recognition system and method thereof are disclosed. In embodiment, a hand posture is recognized according to consecutive hand images first. If the hand posture matches a start posture, the system then separates the consecutive hand images into multiple image groups and calculates motion vectors of these image groups. The distributions of these motion vectors are compared with multiple three-dimensional motion vector histogram equalizations to determine a corresponding movement for each image group. For example, the corresponding movement can be a left moving action, a right moving action, an up moving action or a down moving action. Finally, the combination of these corresponding movements is defined as a gesture, and an instruction mapped to this gesture is then executed.

### TECHNICAL FIELD

The present invention relates generally to vision-based hand movement recognition system and method thereof, more particularly, related to method of separating the consecutive hand images into multiple image groups for recognizing multiple movements, and then determining a gesture according the combination of the movements.

### BACKGROUND

Manual human machine operation interface, such as touch panel control system or posture operation system, allows user to operate computer or play game without using additional device, so as to improve the operation convenience of human machine interface. However, the touch panel system limits user in an operating space where his/her finger can reach the touch panel. The conventional posture operation system also has a disadvantage of bad accuracy.

### SUMMARY OF THE INVENTION

Therefore, an object of the present invention is to provide a vision-based hand movement recognition system and method thereof, for improving gesture recognition accuracy.

The object of the present invention can be achieved by providing a vision-based hand movement recognition system which comprises an image receiving unit, a storage unit, a motion vector calculation unit, a movement determination unit, a gesture recognition unit and an instruction execution unit. The image receiving unit is capable of receiving consecutive hand images and separating said consecutive hand images into multiple image groups. The storage unit stores multiple instructions, multiple predefined motion vector distribution models and multiple predefined gestures, each of said predefined motion vector distribution models corresponding to a predefined movement, and each of the predefined gestures corresponding to one of the instructions. The motion vector calculation unit is capable of calculating motion vectors of each of the image groups. The movement determination unit is capable of comparing motion vector distribution of each of the image groups with the predefined motion vector distribution models, to determine a corresponding movement for each of the image groups from the predefined movements. The gesture recognition unit is capable of comparing combination of the corresponding movements of the image groups with the predefined gestures, to determine a selected instruction from the instructions. The instruction execution unit then executes the selected instruction.

Preferably, the system can further comprise a hand posture recognition unit to recognize a hand posture according to the consecutive hand images, and determine whether the hand posture matches a start posture or an end posture.

Preferably, the motion vector calculation unit calculates the motion vectors according to the first image and the last image of the image group.

Preferably, the predefined motion vector distribution model is a three-dimensional motion vector histogram equalization.

Preferably, the movement determination unit can calculate Euclidean distances between motion vector distribution of the image group and the predefined motion vector distribution models, and determines the corresponding movement according to the Euclidean distances.

Preferably, the predefined movements can comprise a left moving action, a right moving action, an up moving action and a down moving action.

The object of the present invention can be achieved by providing a vision-based hand movement recognition method which comprises following steps: (A) providing multiple instructions, multiple predefined motion vector distribution models and multiple predefined gestures, each of the predefined motion vector distribution models corresponding to a predefined movement, and each of the predefined gestures corresponding to one of the instructions; (B) separating consecutive hand images into multiple image groups; (C) calculating motion vectors of each of the image groups; (D) comparing motion vector distribution of each of the image groups with the predefined motion vector distribution models, to determine a corresponding movement for each of the image groups from the predefined movements; (E) comparing combination of the corresponding movements of the image groups with the predefined gestures, to determine a selected instruction from the instructions; (F) executing the selected instruction.

Preferably, the method further comprises steps of: recognizing a hand posture according to the consecutive hand images; starting step (C) if said hand posture matches a start posture; stopping step (C) if said hand posture matches an end posture.

Preferably, the step (C) further comprises a step of calculating the motion vectors according to a first image and a last image of the image group.

Preferably, the predefined motion vector distribution model is a three-dimensional motion vector histogram equalization.

Preferably, the step (D) further comprises steps of: calculating Euclidean distances between motion vector distribution of the image group and the predefined motion vector distribution models; determining the corresponding movement according to the Euclidean distances.

Preferably, the predefined movements comprise a left moving action, a right moving action, an up moving action and a down moving action.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

The accompanying drawings, which are included to provide a further understanding of the invention, illustrate embodiments of the invention and together with the description serve to explain the principle of the invention.

FIG. 1 illustrates an exemplary block diagram of vision-based hand movement recognition system in accordance with the present invention;

FIG. 2 illustrates an exemplary block diagram of vision-based hand movement recognition system in accordance with the present invention;

FIG. 3 illustrates an example of distribution of motion vectors in accordance with the present invention;

FIG. 4 illustrates a first exemplary flow chart of vision-based hand movement recognition method in accordance with the present invention; and

FIG. 5 illustrates a second exemplary flow chart of vision-based hand movement recognition method in accordance with the present invention.

### DETAILED DESCRIPTION OF THE PREFERRED EMBODIMENTS

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

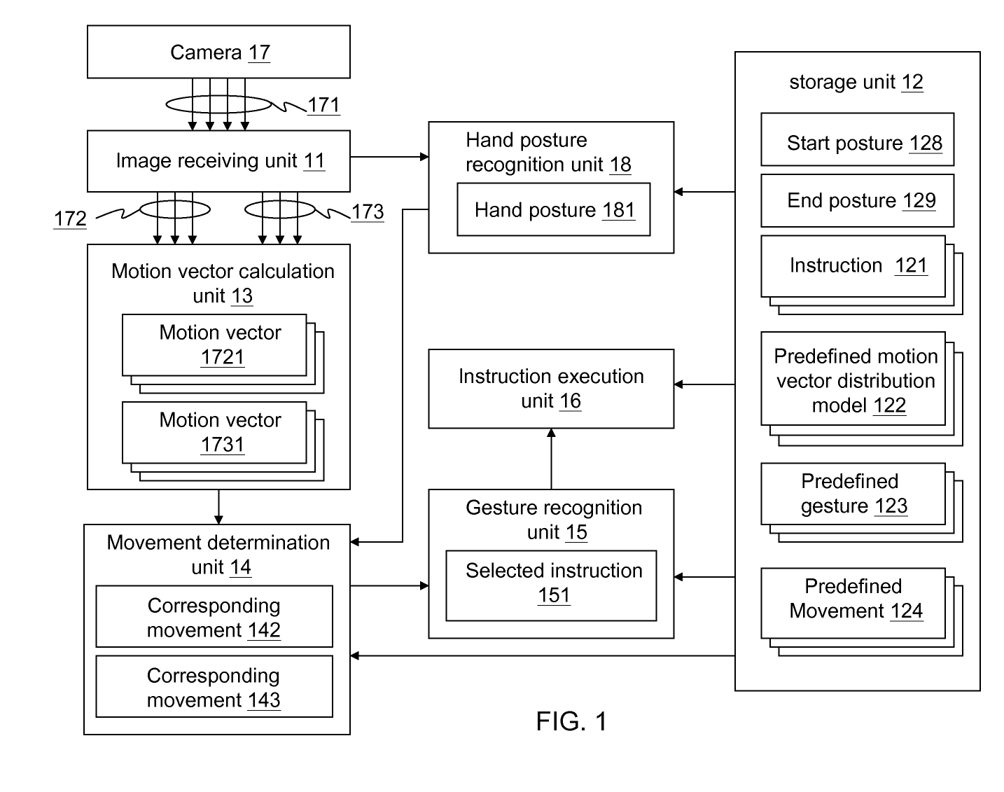

FIG. 1 illustrates an exemplary block diagram of vision-based hand movement recognition system in accordance with the present invention. The system comprises an image receiving unit 11, a storage unit 12, a motion vector calculation unit 13, a movement determination unit 14, a gesture recognition unit 15 and an instruction execution unit 16. The storage unit 12 is used to store multiple instructions 121, multiple predefined motion vector distribution models 122 and multiple predefined gestures 123. Each predefined motion vector distribution model 122 corresponds to a predefined movement 124, and each predefined gesture 123 corresponds to an instruction 124. Preferably, the predefined movements 12 can comprise a left moving action, a right moving action, an up moving action and a down moving action. The image receiving unit 11 is capable of receiving consecutive hand images 171 from a camera 17 and separating the consecutive hand images 171 into multiple image groups. In FIG. 1, a first image group 172 and a second image group 173 are used to represent multiple image groups.

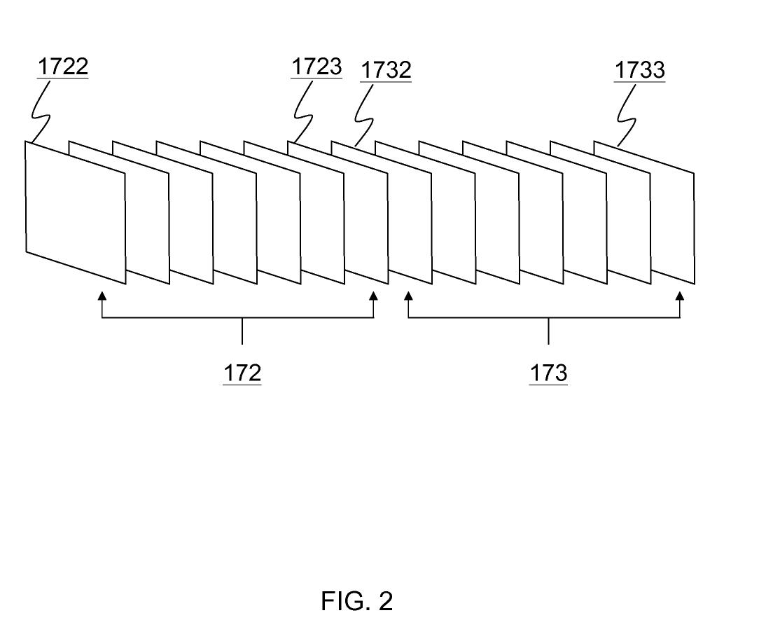

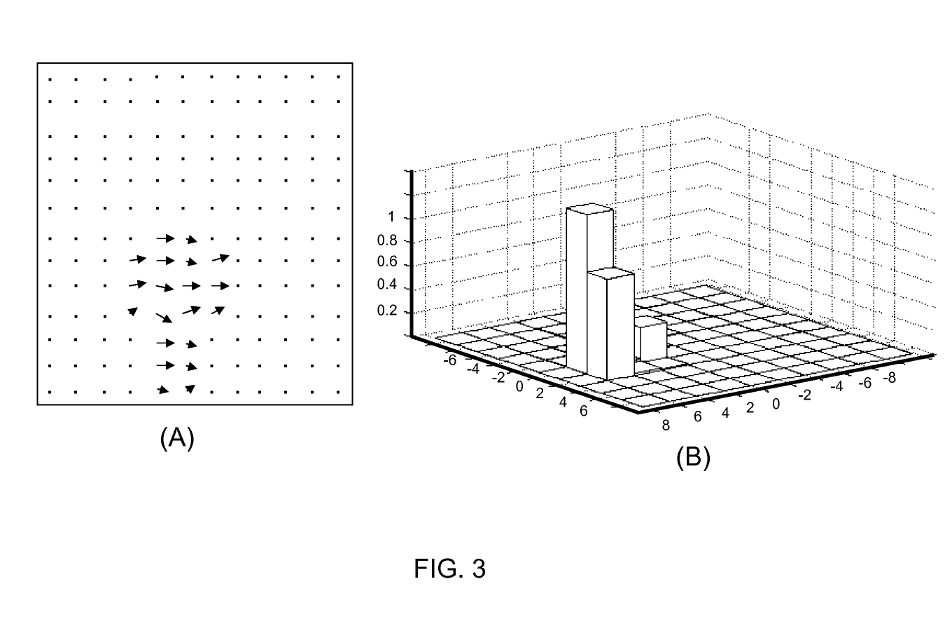

The motion vector calculation unit 13 is capable of calculating motion vectors 1721 of the first image group 172 and motion vectors 1731 of the second image group 173. Preferably, the motion vector calculation unit 13 calculates these motion vectors according to the first image and the last image of image group. For example, referring to FIG. 2 which illustrates an exemplary block diagram of vision-based hand movement recognition system in accordance with the present invention, the first image group 172 and the second image group 173 respectively comprise 7 hand images. The motion vector calculation unit 13 calculates motion vectors 1721 according to the hand image 1722 and the hand image 1723, and calculates motion vectors 1731 according to the hand image 1732 and the hand image 1733, such as example (A) shown in FIG. 3. The movement determination unit 14 is capable of comparing distribution of motion vector 1721, and distribution of motion vector 1731 with the predefined motion vector distribution models 122, to determine a corresponding movement 142 for the first image group 172 and a corresponding movement 143 for the second image group 173 from these predefined movements 124. Preferably, the predefined motion vector distribution model 122 is a three-dimensional motion vector histogram equalization, such as example (B) shown in FIG. 3. For example, the movement determination unit 14 calculates Euclidean distances between distribution of motion vector 1721 of the first image group 172 and the three-dimensional motion vector histogram equalizations, and then determines the corresponding movement 142 according to the Euclidean distances. The manner of calculating motion vector of two images, and the manner of calculating Euclidean distance are well known by ordinary skilled person in image process field, so it is not explained in detail here. The gesture recognition unit 15 is capable of comparing combination of the corresponding movements 142 and the corresponding movement 143, with predefined gestures 123, to determine a selected instruction 151 from the instructions 121. The instruction execution unit 16 then executes the selected instruction 151.

Preferably, the storage unit 12 can further store a start posture 128 and an end posture 129. The hand posture recognition unit 18 is used to recognize a hand posture 181 according to the consecutive hand images 171, and determine whether the hand posture 181 matches the start posture 128 or the end posture 129. If the hand posture 181 matches the start posture 128, the movement determination unit 14 starts to perform calculation of the motion vector; if the hand posture 181 matches the end posture 129, the movement determination unit 14 stops performing calculation of the motion vector.

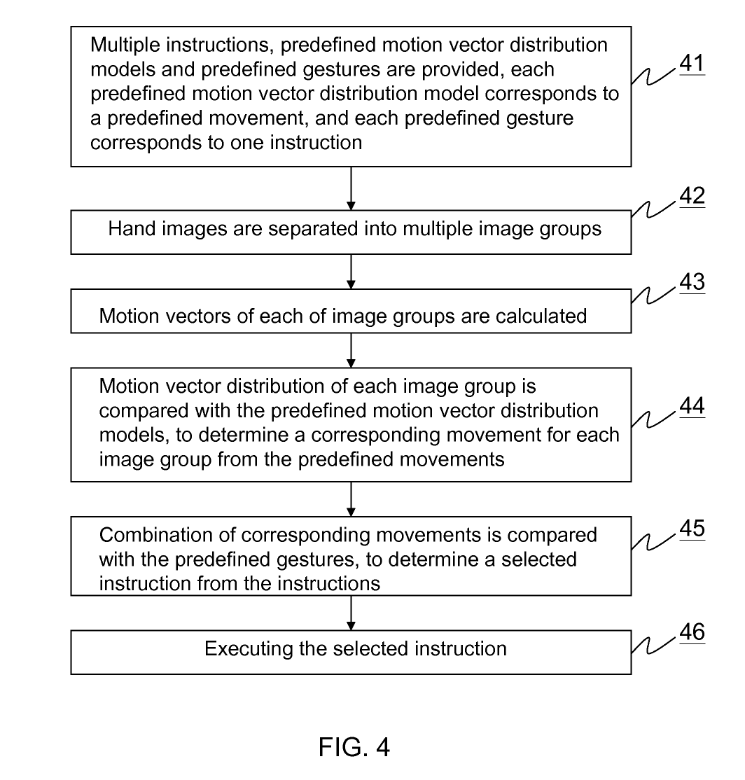

FIG. 4 illustrates a first exemplary flow chart of vision-based hand movement recognition method in accordance with the present invention. This flow chart comprises the following steps. In step 41, providing multiple instructions, multiple predefined motion vector distribution models and multiple predefined gestures are provided. Each predefined motion vector distribution model corresponds to a predefined movement, and each predefined gesture corresponds to one instruction. In step 42, consecutive hand images are received and separated into multiple image groups, as shown in FIG. 2. In step 43 motion vectors of each of image groups are calculated, such as example (A) shown in FIG. 3. Preferably, the motion vectors are calculated according to the first hand image and last hand image of the image group. In step 44, motion vector distribution of each image group is compared with the predefined motion vector distribution models, to determine a corresponding movement for each image group from the predefined movements. Preferably, the predefined motion vector distribution model is a three dimensional motion vector histogram equalization, such as example (B) shown in FIG. 3. In implementation, the Euclidean distances between motion vector distribution of each image group and the predefined motion vector distribution models are calculated first, and the corresponding movement for each image group is determined according to the Euclidean distances. Preferably, the corresponding movement can be a left moving action, a right moving action, an up moving action or a down moving action.

In step 45, combination of corresponding movements of these image groups is compared with the predefined gestures, to determine a selected instruction from the instructions. Finally, in step 46 such selected instruction is executed.

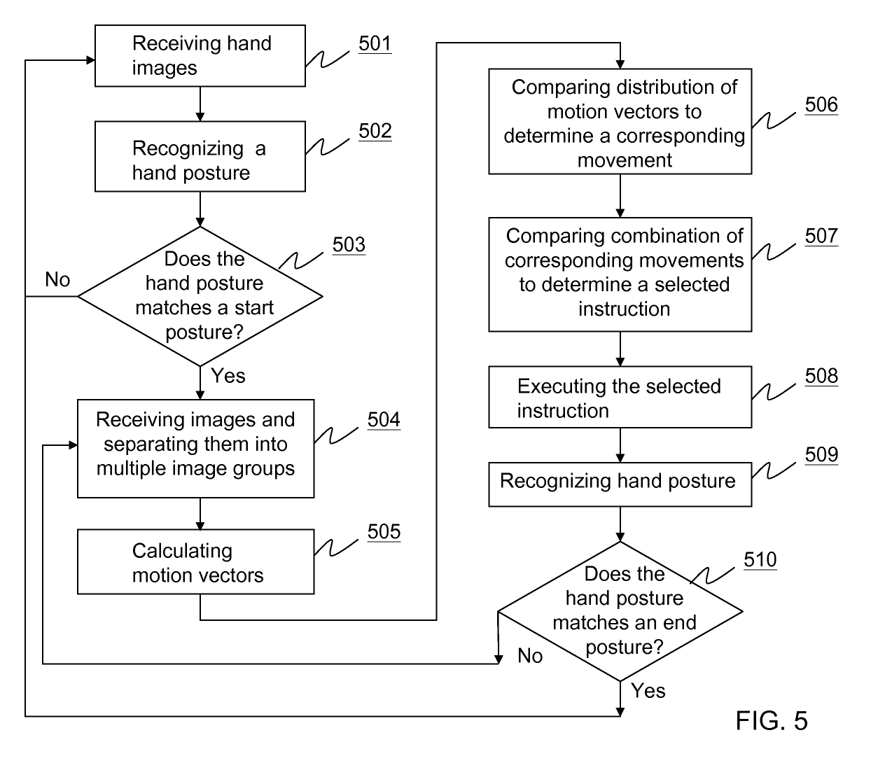

FIG. 5 illustrates a second exemplary flow chart of vision-based hand movement recognition method in accordance with the present invention. The second exemplary flow chart is applied for the vision-based hand movement recognition system shown in FIG. 1. In step 501, the image receiving unit 11 receives consecutive hand images 171. In step 502, the hand recognition unit 18 recognizes a hand posture 181 according to consecutive hand images 171. In step 503, hand recognition unit 18 determines whether the hand posture 181 matches the start posture 128. If the hand posture 181 des not match the start posture 128, the step 501 is then executed. If the hand posture 181 matches the start posture 128, in step 504 the image receiving unit 11 receives consecutive hand images 171 which are separated into first image group 172 and second image group 173. It is noted that consecutive hand images 171 can be, if necessary, separated into more than two image groups. In step 505, the motion vector calculation unit 13 calculates motion vectors 1721 according to the first hand image and the last hand image of first image group 172, and calculates motion vectors 1731 according to the first hand image and the last hand image of second image group 173. In step 506, the movement determination unit 14 respectively compares distribution of motion vectors 1721 and distribution of motion vectors 1731 with the predefined motion vector distribution models 122, to determine a corresponding movement for first image group 172 and a corresponding movement for second image group 173 from the predefined movements 124.

In step 507, the corresponding movement for first image group 172 and second image group 173 are combined to compare with the multiple predefined gestures 123, and according to the comparison result, a selected instruction 151 is determined from the instructions 121. In step 508, the selected instruction is executed by the instruction execution unit 16. In step 509 the hand recognition unit 18 recognizes the hand posture 181 according to consecutive hand images 171, and in step 510 the hand recognition unit 18 determines whether the hand posture 181 matches the end posture 129. If the hand posture 181 matches the end posture 129, the step 501 is then executed; otherwise, the step 504 is then executed.

Thus, specific embodiments and applications of vision-based hand movement recognition system and method thereof have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the invention. In addition, where the specification and claims refer to at least one of something selected from the group consisting of A, B, C . . . and N, the text should be interpreted as requiring only one element from the group, not A plus N, or B plus N, etc.

What is claimed is:

1. A vision-based hand movement recognition system, comprising:
an image receiving unit, receiving consecutive hand images, and separating said consecutive hand images into multiple image groups;
a storage unit, storing multiple instructions, multiple predefined motion vector distribution models and multiple predefined gestures, each of said predefined motion vector distribution models corresponding to a predefined movement, and each of said predefined gestures corresponding to one of said instructions;
a motion vector calculation unit, calculating motion vectors of each of said image groups;
a movement determination unit, comparing distribution of motion vectors of each of said image groups with said predefined motion vector distribution models, to determine a corresponding movement for each of said image groups from said predefined movements;
a gesture recognition unit, comparing combination of said corresponding movements of said image groups with said predefined gestures, to determine a selected instruction from said instructions; and
an instruction execution unit, executing said selected instruction.

2. The vision-based hand movement recognition system of claim 1, further comprising a hand posture recognition unit to recognize a hand posture according to said consecutive hand images, and determine whether said hand posture matches a start posture or an end posture.

3. The vision-based hand movement recognition system of claim 1, wherein said motion vector calculation unit calculates said motion vectors according to the first hand image and the last hand image of said image group.

4. The vision-based hand movement recognition system of claim 1, wherein said predefined motion vector distribution model is a three-dimensional motion vector histogram equalization.

5. The vision-based hand movement recognition system of claim 4, wherein said movement determination unit calculates Euclidean distances between motion vector distribution of said image group and said predefined motion vector distribution models, and determines said corresponding movement according to said Euclidean distances.

6. The vision-based hand movement recognition system of claim 1, wherein said predefined movements comprise a left moving action, a right moving action, an up moving action and a down moving action.

7. A vision-based hand movement recognition method, comprising steps of:
(A) providing multiple instructions, multiple predefined Motion vector distribution models and multiple predefined gestures, each of said predefined motion vector distribution models corresponding to a predefined movement, and each of said predefined gestures corresponding to one of said instructions;
(B) separating consecutive hand images into multiple image groups;
(C) calculating motion vectors of each of said image groups;
(D) comparing distribution of motion vectors of each of said image groups with said predefined motion vector distribution models, to determine a corresponding movement for each of said image groups from said predefined movements;
(E) comparing combination of said corresponding movements of said image groups with said predefined gestures, to determine a selected instruction from said instructions; and
(F) executing said selected instruction.

8. The vision-based hand movement recognition method of claim 7, further comprising steps of:
recognizing a hand posture according to said consecutive hand images;
starting step (C) if said hand posture matches a start posture; and
stopping step (C) if said hand posture matches an end posture.

9. The vision-based hand movement recognition method of claim 7, wherein said step (C) further comprising a step of:
calculating said motion vectors according to a first hand image and a last hand image of said image group.

10. The vision-based hand movement recognition method of claim 7, wherein said predefined motion vector distribution model is a three-dimensional motion vector histogram equalization.

11. The vision-based hand movement recognition method of claim 10, wherein said step (D) further comprising a step of:
calculating Euclidean distances between motion vector distribution of said image group and said predefined motion vector distribution models; and
determining said corresponding movement according to said Euclidean distances.

12. The vision-based hand movement recognition method of claim 7, wherein said predefined movements comprise a left moving action, a right moving action, an up moving action and a down moving action.
